(19) United States
(12) Patent Application Publication
(10) Pub. No.: US 2016/0377413 A1
(43) Pub. Date: Dec. 29, 2016

(54) Methods and devices for detection of movements and deformations of bodies or parts thereof

(71) Applicants: Iakov Goldberg, Saint-Petersburb (RU); Grigory Yezersky, Farmington Hills, MI (US); Victor Levitin, Ida-virumaa (EE); Sergey Vasilevich, Saint-Petersburg (RU)

(72) Inventors: Iakov Goldberg, Saint-Petersburb (RU); Grigory Yezersky, Farmington Hills, MI (US); Victor Levitin, Ida-virumaa (EE); Sergey Vasilevich, Saint-Petersburg (RU)

(21) Appl. No.: 14/747,115

(22) Filed: Jun. 23, 2015

(51) Int. Cl. G01B 11/16; G02B 6/43

(52) U.S. Cl. CPC G01B 11/16; G02B 6/43

(57) ABSTRACT

A device for detecting body deformations or movements of a solid body (e.g. human body) includes a light source, a light receiver receiving a light signal and detecting its variations, an elastic lightguide, including optical imperfections, optically connected to the light source and light receiver, and attached to the body. The body's deformations effect the lightguide's deformations, producing the variations. The lightguide can be made as a single-piece or multiple-piece, wherein gaps between the pieces function as optical imperfections. The light variations are converted into electrical signals for further processing by a control system that can be respectively programmed. Particularly, the device can be implemented for monitoring/training human spine movements for treatment. Other implementations are measuring a position, displacement, speed and acceleration of the body or its parts relative to each other. The device can also measure stretching, shifting, shearing, twisting and other deformations of the body.

### FIELD OF THE INVENTION

The invention relates to methods and devices for detection of physico-mechanical parameters of movements or deformations of physical bodies (including a human body) or parts thereof, or of a fluid flow by measuring an intensity of light signals.

### BACKGROUND OF THE INVENTION

There are known inventor's certificates SU1677531, SU1635120, SU1631436, SU1309731, etc. teaching various methods and devices for measuring physical parameters of materials, mostly utilizing ultra-sound.

There is also known a Russian Federation patent No. 2381489 teaching an optic-electrical sensor for measuring deformations and amplitudes of movement of solid bodies. The sensor includes a light source optically connected with an elongated elastic lightguide, in turn, optically connected with a light detector (e.g. a photo-resistor). The lightguide has a surface with a plurality of indentations thereon, so that the surface acquires a corrugated profile. During deformations of the lightguide, the corrugated profile, being deformed, changes the light flux passing through the lightguide, while the changes are detected by the light detector. Though being efficient, the sensor's capability of detecting deformations of the lightguide is limited. The present invention is aimed to improve optic-electrical sensors and broaden the scope of their utilization.

### OBJECTS AND BRIEF SUMMARY OF THE INVENTION

The primary objects of the present invention are to: (a) enhance the capacity of optic-electrical sensors (herein also called ‘optical sensors’), including a lightguide, for detecting deformations of the lightguide caused by solid physical bodies (including parts of a human body) associated therewith; (b) provide the capacity of optical sensors for detecting a movement (including an accelerated/decelerated movement) of the lightguide (or parts thereof moving relative to each other) and solid physical bodies associated therewith; (c) provide the capacity of optical sensors for detecting externally caused oscillations (including seismic oscillations) of the lightguide and solid physical bodies associated therewith; (d) provide the capacity of optical sensors for detecting a direction and/or speed of a fluid flow surrounding the optical sensors; I provide the capacity of optical sensors for detecting a direction and/or speed of solid bodies, associated with the optical sensors, surrounded by a fluid flow; and (f) provide examples of processing of signals of the optical sensor.

Those skilled in the art will appreciate that the concept, upon which this disclosure is based, may readily be utilized as a basis for the designing of other devices and methods for carrying out several other objects of the present invention. It is therefore important that the appended claims be regarded as including such equivalent constructions insofar as they do not depart from the spirit and scope of the present invention.

The instant inventors have discovered that the capacity of optical sensors for detecting deformations of the lightguide can be significantly improved by changing the configuration and internal structure of the lightguide, rather than changing its surface, as it was done in the aforementioned patent RU2381489. This discovery is an essential feature for the achievement of aforementioned objects of the present invention.

The present invention proposes a device for detecting deformations or movements of a solid body (e.g. a human body) in relation to other bodies, or to a fluid flow (and vice-versa); for detecting oscillations (e.g. seismic oscillations) and their parameters; and for detecting deformations or movements of parts of one body. The device comprises: —a light signal source emitting a light signal; —a light signal receiver receiving the light signal and detecting its variations; —an elastic lightguide including optical imperfections/inhomogeneities, optically connected to the light signal source and the light signal receiver, and attached to the body. The body's deformations effect the lightguide's deformations, producing the variations. The lightguide can be made as a single-piece, or a multiple-piece, wherein gaps between the pieces can function as optical imperfections. The light variations are converted into electrical signals for further processing by a control system that can be respectively programmed. Particularly, the device can be implemented for monitoring/training human spine movements for treatment. Other implementations are: measuring a position, displacement, speed and acceleration/deceleration of movements of the body or its parts in relation to each other. The device can also be implemented to measure stretching, shifting, shearing, twisting and other deformations of the body.

### BRIEF DESCRIPTION OF DRAWINGS OF THE INVENTION

FIGS. 1A, 1B schematically show a longitudinal cross-section of the optical sensor in its initial position and the distribution of light beams therein, according to a preferred embodiment of the present invention.

FIGS. 2A, 2B schematically show a longitudinal cross-section of the optical sensor being deformed (bent) in a direction transverse to the longitudinal cross-section and the distribution of light beams therein, according to the preferred embodiment of the present invention shown in FIGS. 1A, 1B.

FIGS. 3A, 3B schematically show a longitudinal cross-section of the optical sensor in its initial position, wherein the optical sensor includes a lightguide composed of a plurality of pieces separated from each other by gaps, and the distribution of light beams therein, according to another preferred embodiment of the present invention.

FIGS. 4A, 4B schematically show a longitudinal cross-section of the optical sensor being deformed (bent) in a direction transverse to the longitudinal cross-section and the distribution of light beams therein, according to the preferred embodiment of the present invention shown in FIGS. 3A, 3B.

FIGS. 5A, 5B schematically show a longitudinal cross-section of the optical sensor being deformed (longitudinally stretched—FIG. 5B), wherein the optical sensor includes a lightguide composed of a plurality (in this case, two) of pieces separated from each other by gaps, and the distribution of light beams therein, according to another preferred embodiment of the present invention.

FIG. 5C, 5D schematically show a transversal cross-section of the optical sensor being deformed (twisted) in a direction transverse to the longitudinal cross-section (FIG. 5D) and the distribution of light beams therein, according to the preferred embodiment of the present invention shown in FIG. 5A.

FIG. 5E schematically shows a longitudinal cross-section of the optical sensor being deformed (shifted) in a direction transverse to the longitudinal cross-section and the distribution of light beams therein, according to the preferred embodiment of the present invention shown in FIG. 5A.

FIGS. 6A, 6B schematically show a longitudinal cross-section of the optical sensor coupled to an elongated object being deformed (bent) in a direction transverse to the longitudinal cross-section (FIG. 6B) and the distribution of light beams therein, according to another preferred embodiment of the present invention.

FIGS. 6C, 6D schematically show a longitudinal cross-section of the optical sensor coupled to two elongated objects being angularly turned in relation to each other within a plane of the longitudinal cross-section (FIG. 6D), according to another preferred embodiment of the present invention.

FIG. 7A schematically shows a longitudinal cross-section of the optical sensor coupled to a body moving with an acceleration, while the optical sensor is deformed (bent) respectively to the acceleration, according to another preferred embodiment of the present invention.

FIG. 7B schematically shows a longitudinal cross-section of the optical sensor coupled to a tubular object, through which a fluid flow is passed, while a lower portion of the optical sensor is deformed (bent) in a direction concurrent to the fluid flow, according to another preferred embodiment of the present invention.

FIG. 7C schematically shows a longitudinal cross-section of the optical sensor, whose left portion is coupled to a solid body subjected to oscillations (e.g. seismic oscillations), while its right portion of the optical sensor is freely oscillated, according to another preferred embodiment of the present invention.

FIG. 8A schematically shows a longitudinal cross-section of the optical sensor, whose first end is coupled to an upper part of a body subjected to shearing deformation, and whose second end is coupled to a support surface, which a lower part of the body rests upon, causing the optical sensor to be deformed (bent), according to another preferred embodiment of the present invention.

FIG. 8B schematically shows a longitudinal cross-section of the optical sensor, whose first end is coupled to an upper part of a body moving (e.g. rolling) upon a support surface, and whose second end is coupled to the support surface, causing the optical sensor to be deformed (bent), according to another preferred embodiment of the present invention.

FIGS. 9A, 9B, 9C and 9D schematically show the optical sensor coupled to different parts of a human body causing the optical sensor to be deformed (bent) in response to deformations or relative movements of the human body's parts, according to another preferred embodiment of the present invention.

FIG. 10 shows a flowchart depicting a system for processing of signals of the optical sensor, as well as its communication with an external database, a network, an execution unit, and a data entry unit, according to another preferred embodiment of the present invention.

FIG. 11 shows a flowchart depicting an exemplary algorithm for the signal processing in the system, according to the preferred embodiment of the present invention shown in FIG. 10.

### DETAIL DESCRIPTION OF PREFERRED EMBODIMENTS OF THE INVENTION

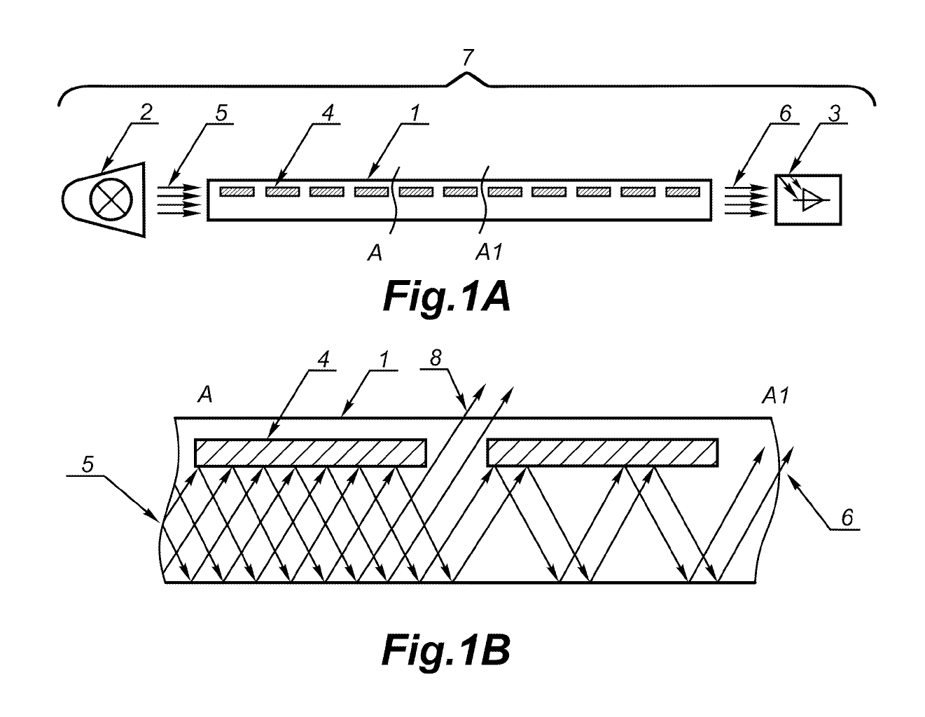

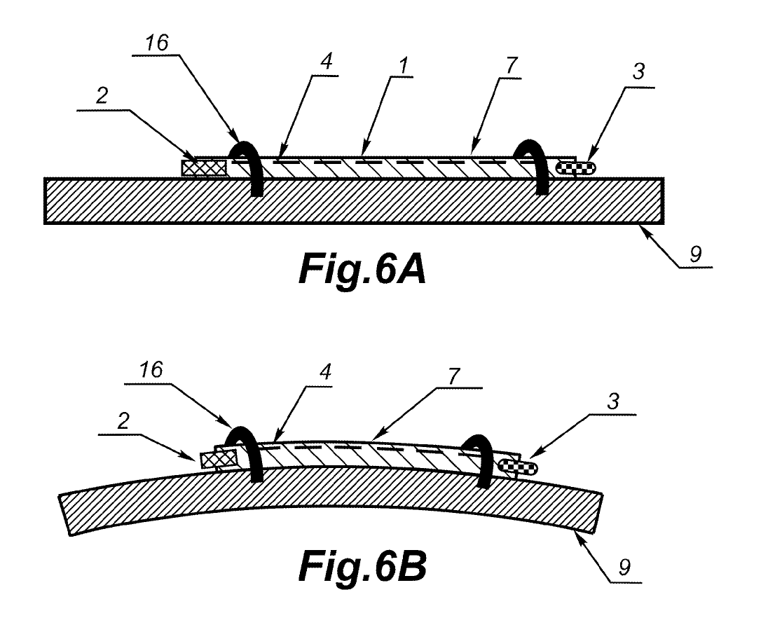

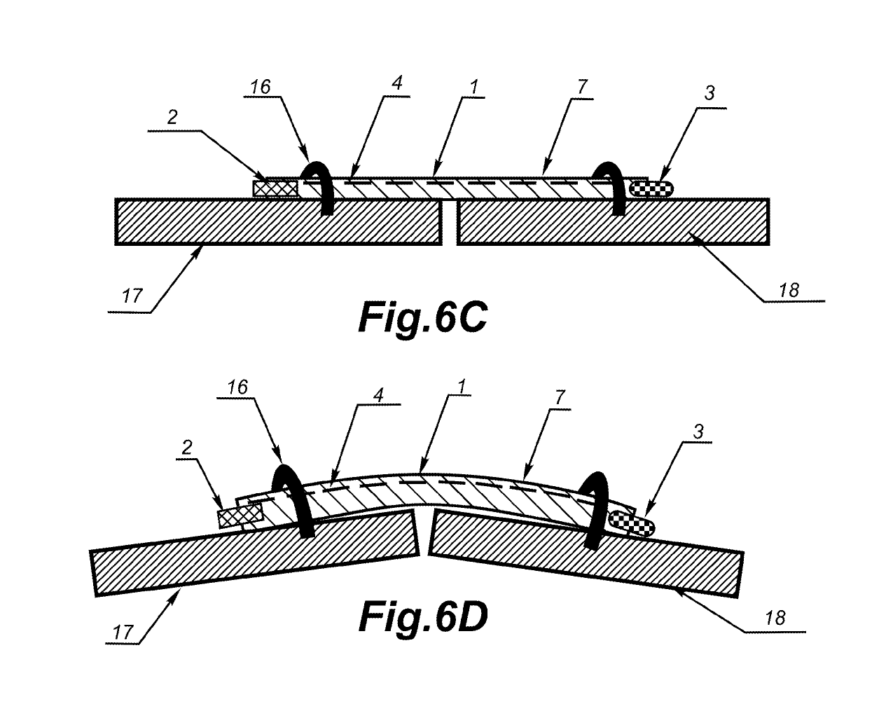

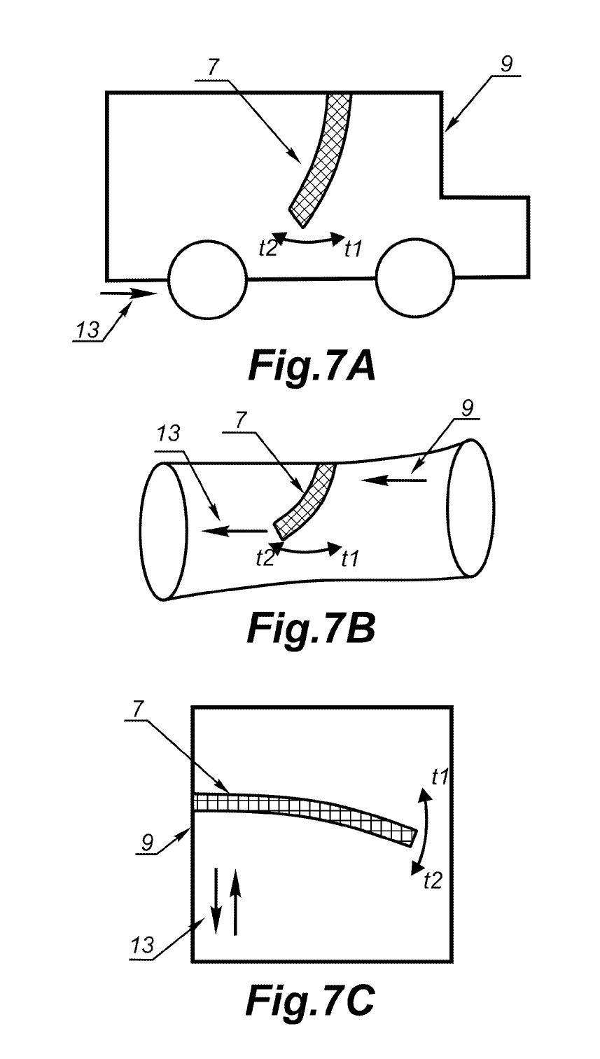

According to an inventive embodiment shown in FIGS. 1A and 1B, a device 7 for detecting deformations of a solid body comprises:—a light signal source 2 emitting an input light signal 5; —a light signal receiver 3 receiving an output light signal 6 being lower than the input light signal 5; —an elongated single-piece lightguide 1 (typically attached to the solid body, for example, as shown in FIG. 6A or 7A) capable of elastic deformation, and providing for a transmission of the input light signal 5 therethrough; the lightguide has a first guide end and a second guide end; the light signal source 2 is optically connected to the first guide end; the light signal receiver 3 is optically connected to the second guide end and is capable of detecting variations of the light signal 6 typically effected by deformations of the solid body; and wherein the lightguide 1 includes predetermined optical inhomogeneities and/or imperfections 4 imparted thereinto.

The predetermined optical inhomogeneities and/or imperfections 4 can be made in the form of: fluid or vacuum inclusions; or solid particles, imparted into the lightguide during manufacturing thereof by utilizing: fermentation, or casting, or 3-D printing, or treatment by a laser beam.

Due to the reflection of light beams from the walls of lightguide 1, from the optical inhomogeneities and/or imperfections 4, as well as due to different optical properties of the walls, the surroundings of the lightguide, and the inhomogeneities and/or imperfections, angles of reflection of the light beams vary along the lightguide 1 during transmission and the beams are dispersed.

FIG. 1B illustrates how the light beams are distributed and dispersed within the lightguide 1, that leads to the reduction of intensity of the light signal at the receiving end depicted by the output light signal 6. As shown in FIG. 1B, a portion 8 of the light beams of the light signal 5 leaves the lightguide 1 not reaching the end point of output signal 6, which results in an intensity of the output light signal 6 being lower than an intensity of the input light signal 5. A common term “light signal” is also used in this description, which means a light signal with an intensity of the input signal reducing to an intensity of the output signal during the transmission of the light signal through the lightguide 1.

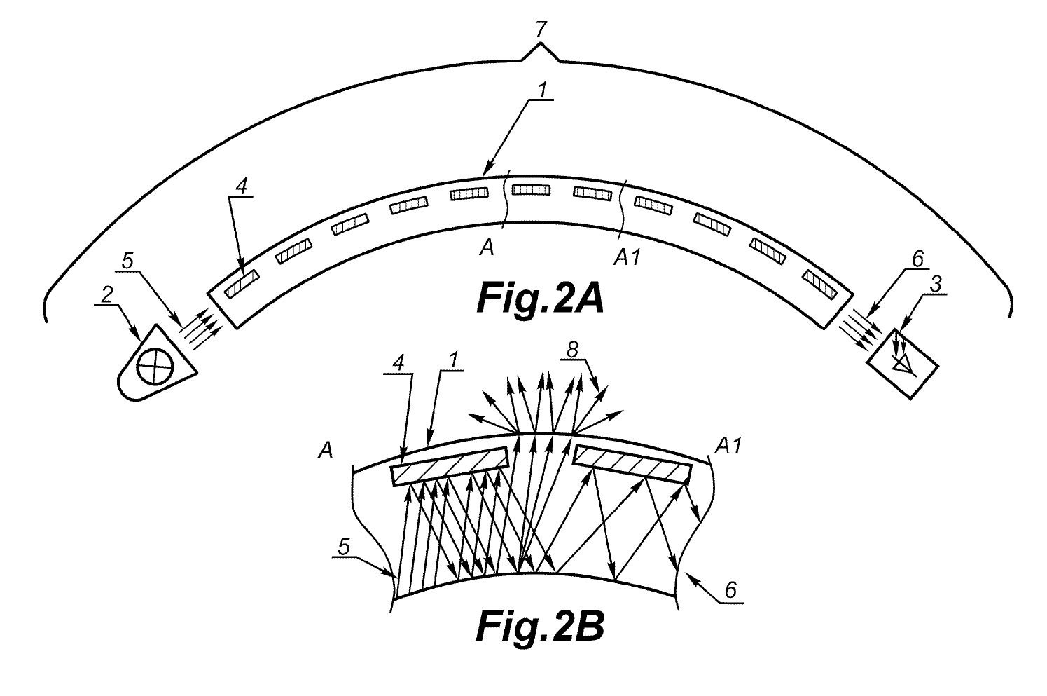

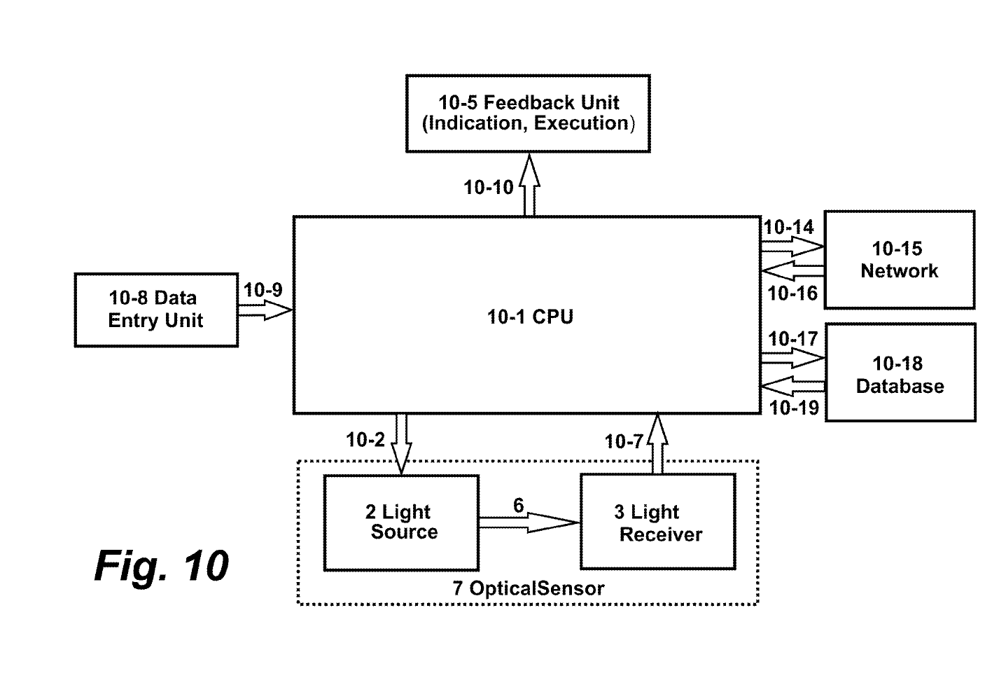

FIGS. 2A, 2B schematically show a longitudinal cross-section of the optical sensor 7, whose lightguide 1 is deformed (bent) in a direction transverse to the longitudinal cross-section and the distribution of light beams therein, according to the preferred embodiment of the present invention shown in FIGS. 1A, 1B. It can be noticed that, in FIG. 2B, the portion 8 of the light beams is greater than the portion 8 in FIG. 1B. This means that the deformation of lightguide 1 can result in a greater reduction of the light signal during its transmission through the lightguide. Therefore, such deformations of the lightguide 1 cause variations of the light signal that can be detected by the light signal receiver 3. For this and all other embodiments of the present invention, the light signal receiver 3 typically includes a device (e.g. a photo-resistor) capable of converting the light signal 6 into an electric signal that can be further processed (for example, see FIG. 10).

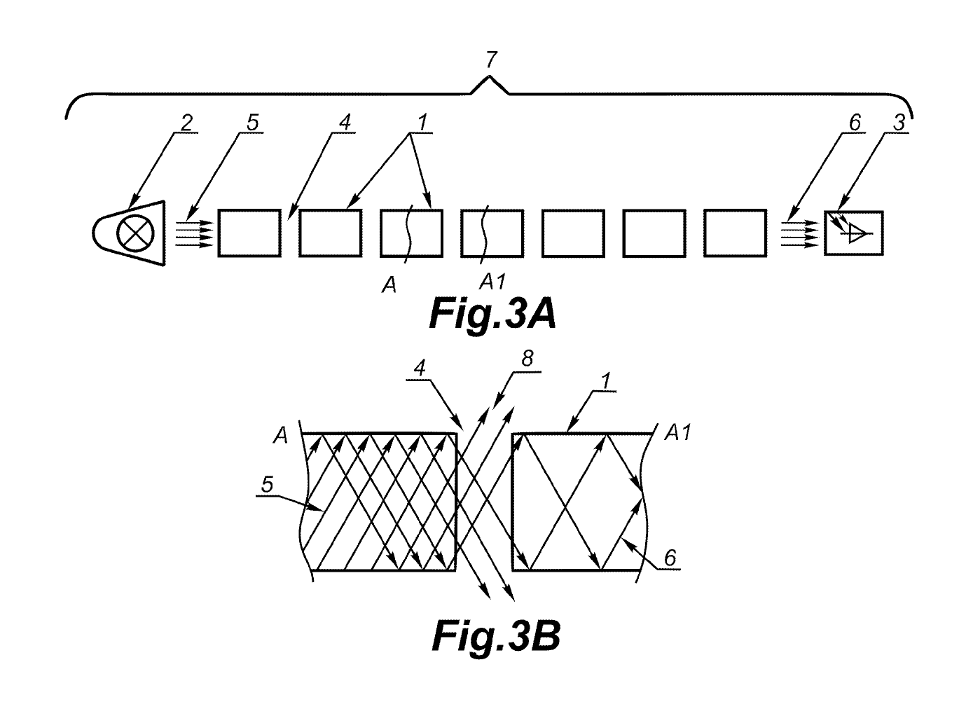

FIG. 3A schematically shows a longitudinal cross-section of the optical sensor 7 in its initial position, wherein the optical sensor comprises a multi-piece lightguide 1 capable of elastic deformation, composed of a plurality of pieces separated from each other by gaps 4, according to another preferred embodiment of the present invention. All the pieces, as well as all the gaps are capable of transmitting the light signal.

FIG. 3B shows the distribution of light beams within the lightguide 1. The input light signal 5 is introduced into a first piece of the lightguide 1 (depicted at a cross-section A). A portion 8 of light beams is dispersed within a first gap 4 of the lightguide 1 adjacent to the first piece of the lightguide 1. It can be said that, in this and other similar embodiments of the present invention, the gap 4 functions similar to the inhomogeneities and/or imperfections of the lightguide 1 in the embodiment shown in FIG. 1. The output light signal 6 (depicted at a cross-section A1) transmitted through the second piece of lightguide 1 is lower than the input light signal 5 due to the dispersed (lost) portion 8.

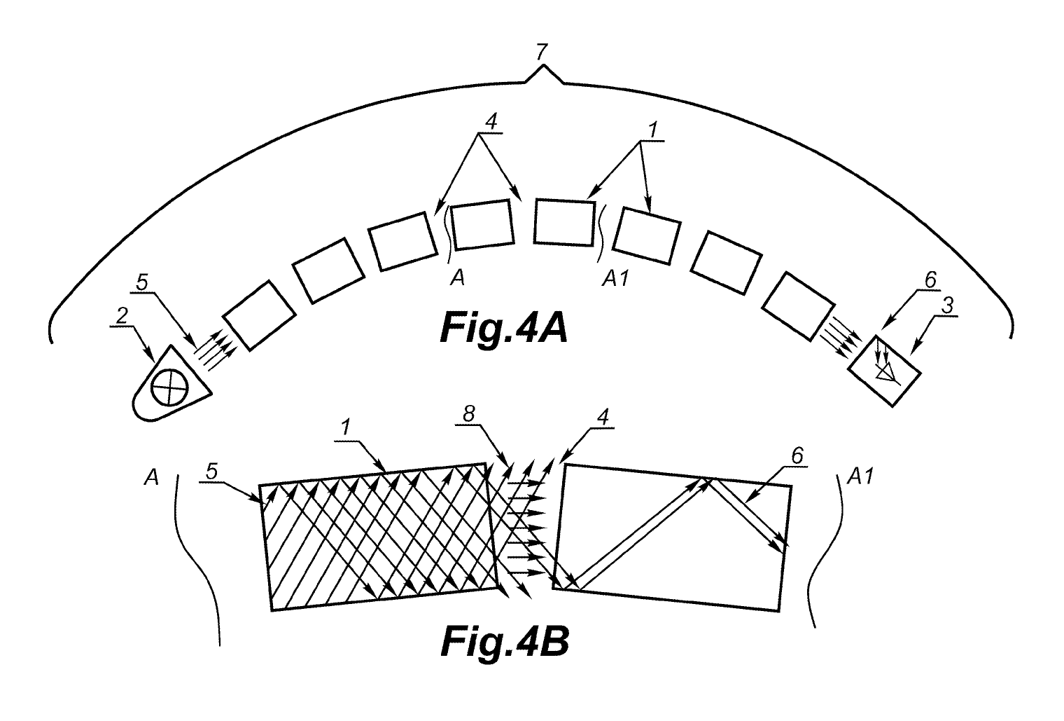

FIGS. 4A, 4B schematically show a longitudinal cross-section of the optical sensor being deformed (bent) in a direction transverse to the longitudinal cross-section and the distribution of light beams therein, according to the preferred embodiment of the present invention shown in FIG. 3A. It can be noticed that, in FIG. 4B, the portion 8 of the light beams is greater than the portion 8 in FIG. 3B due to changing the angles of light beam reflection caused by bending the lightguide 1. This means that the deformation of lightguide 1 can result in a greater reduction of the light signal during its transmission through the lightguide. Therefore, such deformations of the lightguide 1 cause variations of the light signal that can be detected by the light signal receiver 3.

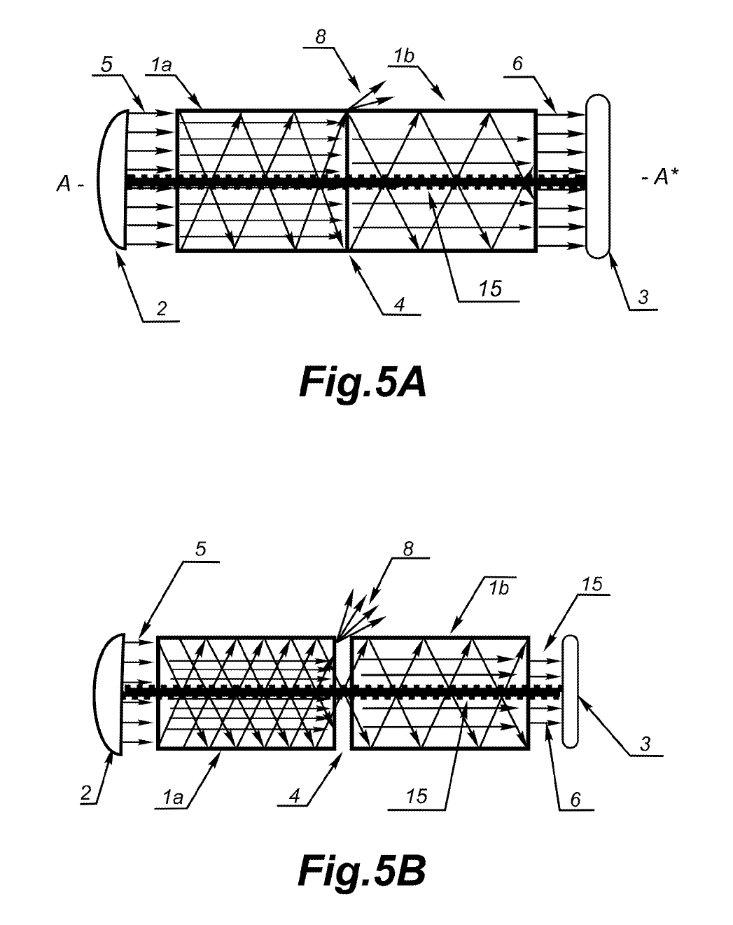

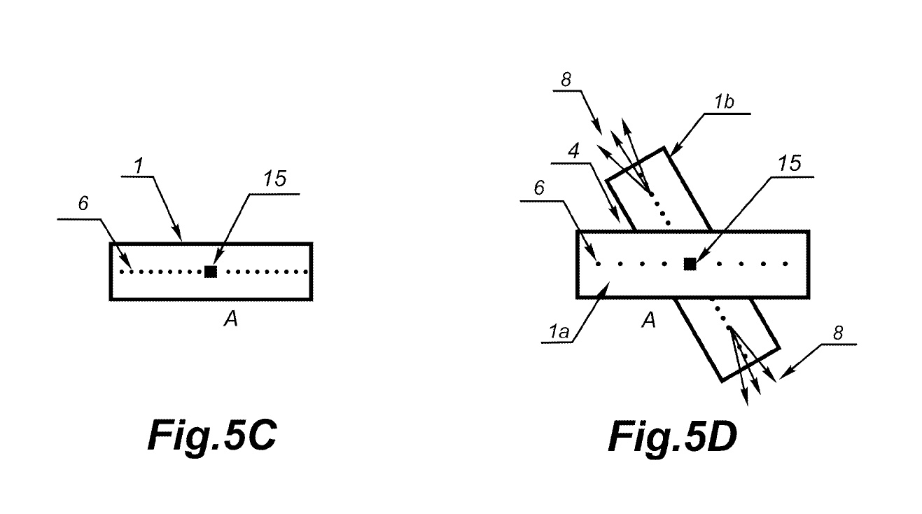

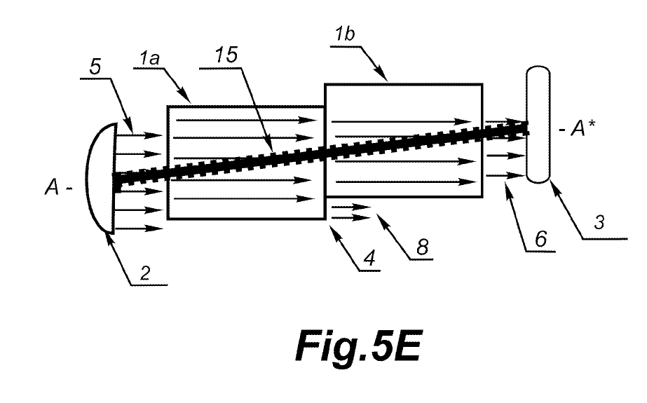

In another preferred embodiment of the present invention depicted in FIGS. 5A, 5B, there is schematically shown a longitudinal cross-section A-A* of the optical sensor 7 comprising: a lightguide 1 composed of a plurality (in this case, two) of pieces—piece 1a and piece 1b—separated from each other by a gap 4, and the distribution of light beams therein. The lightguide pieces 1a and 1b and the gap 4 are capable of transmitting the light signal. A portion 8 of light beams of the input light signal 5 is dispersed (lost), particularly within the gap 4.

The lightguide pieces 1a and 1b are fastened by an elastic member 15, which can be expanded and contracted without damage. The ends of the elastic member 15 can be secured to the light signal source 2 and to the light signal receiver 3.

The elastic member 15 can be made in any of the following forms: an elastic substrate, which the lightguide pieces 1a and 1b are secured to (e.g. glued upon, etc.); an elastic band (bandage) internally threaded through the lightguide pieces 1a and 1b, or externally attached to the lightguide pieces 1a and 1b; a stretchable rope, thread, cable, etc. fastening the lightguide pieces 1a and 1b together; a spring joining the lightguide pieces 1a and 1b together; or the like.

When the lightguide 1 is deformed (e.g. longitudinally stretched as shown in FIG. 5B) causing a widening of the gap 4, it results in an increase of the portion 8 of dispersed light beams comparatively to the portion 8 without the deformation (shown in FIG. 5A). Hence, the intensity of the output light signal 6 is reduced comparatively to the intensity of the output light signal 6 without the deformation (shown in FIG. 5A). Therefore, such stretching deformations of the lightguide 1 cause variations of the light signal that can be detected by the light signal receiver 3.

FIG. 5C, 5D schematically show a transversal cross-section of the optical sensor 7 being deformed (twisted) in a direction transverse to the longitudinal cross-section (FIG. 5D) and the distribution of light beams therein.

According to the preferred embodiment of the present invention shown in FIG. 5A, the optical sensor 7 comprises a lightguide 1 capable of elastic deformation, composed of a plurality (in this case, two) of pieces—piece 1a and piece 1b—separated from each other by a gap 4, and the distribution of light beams therein. The lightguide pieces 1a and 1b and the gap 4 are capable of transmitting the light signal. A portion 8 of light beams of the input light signal 5 is dispersed (lost), particularly within the gap 4, as shown in FIG. 5D.

The lightguide pieces 1a and 1b are fastened by an elastic member 15, which can be twisted without damage. The ends of the elastic member 15 can be secured to the light signal source 2 and to the light signal receiver 3.

When the lightguide 1 is subjected to a transversal torque and deformed (i.e. twisted as shown in FIG. 5D, while the pieces 1a and 1b are moved in relation to each other), it narrows a channel of the gap 4, through which light beams of the input light signal are transmitted from the piece 1a to the piece 1b, which results in an increase of the portion 8 of dispersed light beams comparatively to the portion 8 without the deformation (shown in FIG. 5C). Hence, the intensity of the output light signal is reduced comparatively to the intensity of the output light signal without the deformation (shown in FIG. 5C). Therefore, such twisting deformations of the lightguide 1 cause variations of the light signal that can be detected by the light signal receiver 3.

FIG. 5E schematically shows a longitudinal cross-section of the optical sensor 7 being deformed (shifted) in a direction transverse to the longitudinal cross-section and the distribution of light beams therein, according to the preferred embodiment of the present invention shown in FIG. 5A.

When the lightguide 1 is subjected to a transverse force and deformed (as shown in FIG. 5E, while the pieces 1a and 1b are moved in relation to each other), it narrows a channel of the gap 4, through which light beams of the input light signal are transmitted from the piece 1a to the piece 1b, which results in an increase of the portion 8 of dispersed light beams comparatively to the portion 8 without the deformation (shown in FIG. 5A). Hence, the intensity of the output light signal is reduced comparatively to the intensity of the output light signal without the deformation (shown in FIG. 5A). Therefore, such shifting deformations of the lightguide 1 cause variations of the light signal that can be detected by the light signal receiver 3.

FIGS. 6A, 6B schematically show a longitudinal cross-section of the optical sensor 7, made according to the embodiment shown in FIG. 1A, and coupled to an elongated object (body) 9 being deformed (bent) in a direction transverse to the longitudinal cross-section (FIG. 6B), according to another preferred embodiment of the present invention. Alternatively, the lightguide 1 can be composed of a plurality of pieces separated from each other by gaps, similar to the one shown in FIG. 3A.

As shown in FIGS. 6A, 6B, the lightguide 1 is immovably attached to the object 9 by brackets 16. The attachment can also be provided entirely or partially (i.e. at predetermined spots or continuous portions/zones of the object) along the longitudinal length of the object 9 by the following:—gluing, —scotch-tape coupling, —a means using inter-molecular or magnetic attraction, —Velcro I, —staples, —elastic sleeves put on the lightguide 1 and the object 9, —various mechanical fasteners, or the like.

When the object 9 is bent, the lightguide 1 is also bent (as shown in FIG. 6B), which results in an increase of the portion 8 of dispersed light beams comparatively to that portion 8 without the deformation (shown in FIG. 1A). Hence, the intensity of the output light signal 6 is reduced comparatively to the intensity of the output light signal 6 without the deformation (shown in FIG. 1A). Therefore, such bending deformations of the object 9 cause variations of the light signal that can be detected by the light signal receiver 3.

According to another preferred embodiment of the present invention, FIGS. 6C, 6D schematically show a longitudinal cross-section of the optical sensor 7, made according to the inventive embodiment shown in FIGS. 1A, 2A, including the lightguide 1 coupled by brackets 16 to two adjacently disposed elongated objects 17 and 18. The objects 17 and 18 are initially aligned along a straight line that is depicted in FIG. 6C. The objects 17 and 18 are then moved (turned) in relation to each other within a plane of the longitudinal cross-section (depicted in FIG. 6D). The movement causes a bending deformation of the lightguide 1 similar to the one shown in FIGS. 2A, 2B. Analogously to the embodiment shown in FIG. 2A, the bending deformation of the lightguide 1 (i.e. factually, the movement of the two objects or their mutual position effecting the deformation) causes variations of the light signal that can be detected by the light signal receiver 3.

The objects 17 and 18 can represent two different parts of one body (including a human's body) moving in relation to each other. The lightguide 1 can be composed of a plurality of pieces separated from each other by gaps, similar to the one shown in FIG. 3A.

The above-described inventive embodiment can be modified by using the optical sensor 7, whose lightguide 1 is composed of a plurality of pieces (as shown in FIG. 3A), instead of the whole lightguide 1 made according to the embodiment shown in FIG. 1A. Different pieces of the lightguide 1 can be attached by suitable known means to a plurality of objects in predetermined configurations, or to different parts of one body (not illustrated). Then, the bending deformation of the lightguide 1 effected by the mutual movements of the plurality of objects or the different parts of one body causes variations of the light signal that can be detected by the light signal receiver 3.

According to another preferred embodiment of the present invention, FIG. 7A schematically shows a longitudinal cross-section of the optical sensor 7 (made according to either the embodiment shown in FIG. 1A, or the embodiment shown in FIG. 3A), including a lightguide 1 (depicted in FIG. 1A, or in FIG. 3A). An upper portion (also called herein ‘an attachment lightguide zone’) of the optical sensor 7 is coupled to a body 9 moving with an acceleration in a direction 13, while a lower portion (also called herein ‘a free lightguide zone’) of the optical sensor 7 is displaced due to inertial forces, respectively to the acceleration, from a position t1 to a position t2 in a direction opposite to the direction 13, thereby deforming (bending) the optical sensor 7. The bending deformation of the lightguide 1 (i.e. factually the displacement t1-t2 or the acceleration effecting the displacement) causes variations of the light signal that can be detected by the light signal receiver 3. In this case, the optical sensor 7 functions as an accelerometer.

According to another preferred embodiment of the present invention, FIG. 7B schematically shows a longitudinal cross-section of the optical sensor 7 (made according to either the embodiment shown in FIG. 1A, or the embodiment shown in FIG. 3A), including a lightguide 1 (depicted in FIG. 1A, or in FIG. 3A). An upper portion (also called herein ‘an attachment lightguide zone’) of the optical sensor 7 is internally coupled to the walls of a tubular (or a similar shape) body 9 capable of passing a flow of fluid (liquid, or gas, or bulk materials) therethrough in a direction 13, while a lower portion (also called herein ‘a free lightguide zone’) of the optical sensor 7 is displaced, due to a pressure applied thereon by the fluid flow, from a position t1 to a position t2 in a direction opposite to the direction 13, thereby deforming (bending) the optical sensor 7. The bending deformation of the lightguide 1 (i.e. factually the displacement t1-t2 or the pressure of the fluid flow effected the displacement) causes variations of the light signal that can be detected by the light signal receiver 3. In this case, the optical sensor 7 can function, for example, as a meter measuring a pressure, or a throughput (if the fluid's density is invariable), or a speed of the fluid flow.

Conversely, according to another preferred embodiment of the present invention, the optical sensor can be attached to an object moving through a fluid environment (such as a ship, aircraft, etc. —not illustrated) and the elastic lightguide of the optical sensor can be adjusted for measuring, for instance, a speed of the moving object.

According to another preferred embodiment of the present invention, FIG. 7C schematically shows a longitudinal cross-section of the optical sensor 7 (made according to either the embodiment shown in FIG. 1A, or the embodiment shown in FIG. 3A), including a lightguide 1 (depicted in FIG. 1A, or in FIG. 3A). An attachment lightguide zone (the left portion) of the optical sensor 7 is coupled to a solid body 9 subjected to oscillations (e.g. seismic oscillations), while a free lightguide zone (the right portion) of the optical sensor 7 is freely oscillated from a position t1 to a position t2, thereby periodically deforming (bending) the optical sensor 7. The oscillating bending deformation of the lightguide 1 (i.e. factually the displacement t1-t2, or the oscillations effecting the displacement) causes variations of the light signal that can be detected by the light signal receiver 3. The optical sensor 7 of this embodiment can measure an amplitude or frequency of oscillations of various objects.

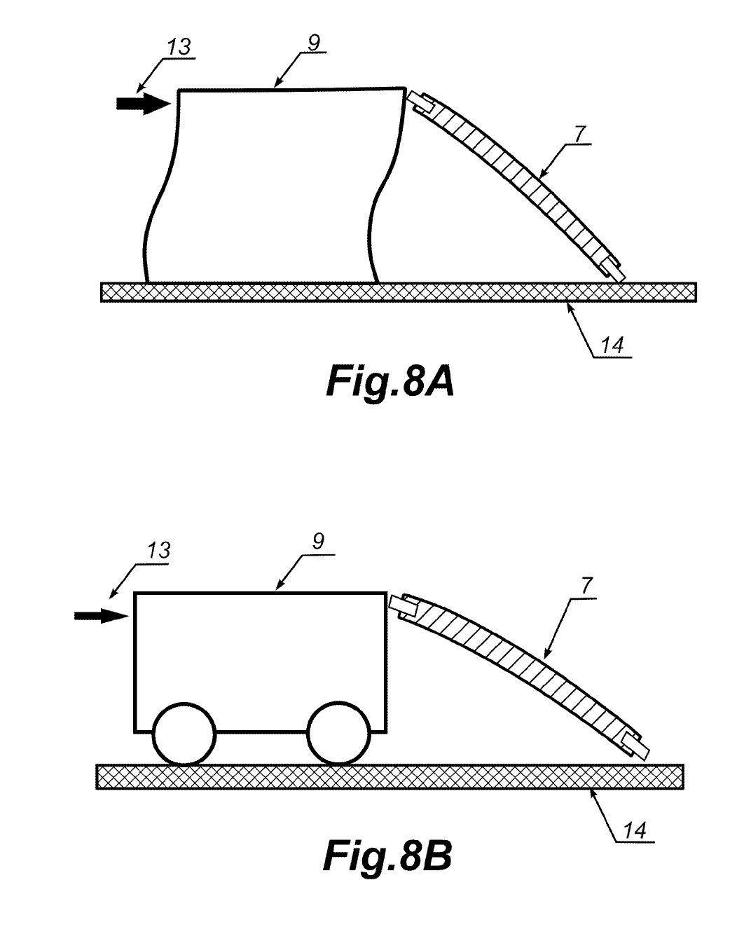

According to another preferred embodiment of the present invention, FIG. 8A schematically shows a longitudinal cross-section of the optical sensor 7 (made according to either the embodiment shown in FIG. 1A, or the embodiment shown in FIG. 3A), whose first end is coupled to an upper part of a body 9 subjected to shearing deformation in a direction 13, and whose second end is coupled to a support surface 14, which a lower part of the body 9 rests upon, causing the optical sensor 7 to be deformed (bent). This bending deformation causes variations of the light signal that can be detected by the light signal receiver 3. The body's deformation can be of different types: shearing, shifting, stretching, twisting, etc. This embodiment allows for measuring parameters of displacement of an object or parts thereof, subjected to such deformations, in relation to other objects.

According to another preferred embodiment of the present invention, FIG. 8B schematically shows a longitudinal cross-section of the optical sensor 7 (made according to either the embodiment shown in FIG. 1A, or the embodiment shown in FIG. 3A), whose first end is coupled to an upper part of a body 9 moving in a direction 13, and whose second end is coupled to a support surface 14, which a lower part of the body 9 rolls upon, causing the optical sensor 7 to be deformed (bent). This bending deformation causes variations of the light signal that can be detected by the light signal receiver 3. This embodiment allows for monitoring or measuring parameters of movements (direction, speed, oscillations, etc.) of an object in relation to other objects.

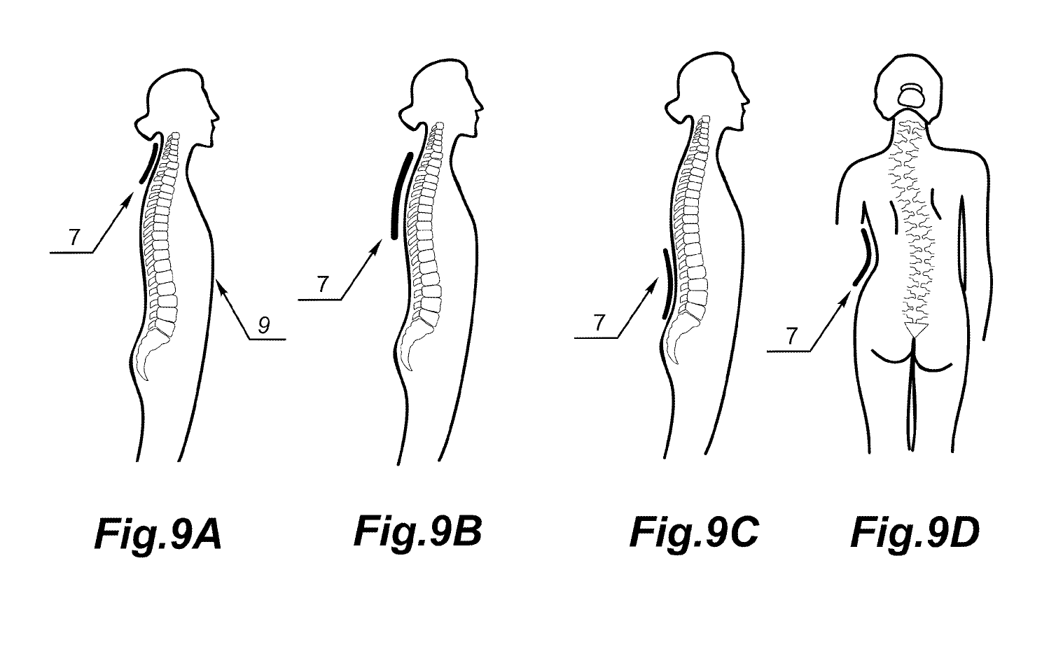

According to another preferred embodiment of the present invention, FIGS. 9A, 9B, 9C and 9D schematically show a longitudinal cross-section of the optical sensor 7 (made according to either the embodiment shown in FIG. 1A, or the embodiment shown in FIG. 3A), coupled to different parts of a human's body 9. During operation, the spine parts are moved, causing the optical sensor 7 to be deformed (bent). This bending deformation causes variations of the light signal that can be detected by the light signal receiver 3.

FIG. 9A shows the optical sensor 7 attached to the cervical section of spine of the human body 9 (depicted in the sagittal plane). This position of the optical sensor can be used for control of spine's bending in case of lordosis. FIG. 9B shows the optical sensor 7 attached to the thoracic section of spine of the human body 9 (depicted in the sagittal plane). This position of the optical sensor can be used for control of spine's bending in case of kyphosis. FIG. 9C shows the optical sensor 7 attached to the lumbar section of spine of the human body 9 (depicted in the sagittal plane). This position of the optical sensor can be used for control of spine's bending in case of lordosis. FIG. 9D shows the optical sensor 7 laterally attached to the thoraco-lumbar section of spine of the human body 9 (depicted in the frontal plane). This position of the optical sensor can be used for control of spine's bending in case of scoliosis.

According to another preferred embodiment of the present invention, FIG. 10 shows a flowchart depicting a control system for processing the signals of the optical sensor 7 (made according to either the embodiment shown in FIG. 1A, or the embodiment shown in FIG. 3A), by means of: a CPU 10-1; an external database 10-18 (including a respective DBMS); a network 10-15 (that may include a number of computers, smart phones, a cloud, or a cluster); a feedback unit 10-5, that, for example, can provide feedback to a patient with the purpose of causing a respective reaction (as shown in the embodiments depicted on FIGS. 9A, 9B, 9C and 9D); or can indicate the operation mode and notify the operator (e.g. when operation parameters exceed predetermined values); and a data entry unit 10-8 that can receive data entries (e.g. commands, limitation values for operation of the CPU, etc.) from the operator (e.g. a doctor, or a patient), or from an external computer program, and transmit them to the CPU. In some inventive embodiments, the feedback unit 10-5 may control an electric circuit supplying voltage to electrodes being in contact with the patient's muscles (not illustrated). In other inventive embodiments (e.g. shown in FIG. 7A) the feedback unit 10-5 may signal when an acceleration of the object exceeds a preset level (not illustrated).

The CPU 10-1 sends a command signal 10-2 that initializes the light signal source 2 of the optical sensor 7, which emits an input light signal 5 (not shown in FIG. 10, but shown in FIGS. 1A, 3A, etc.) transmitted via the lightguide 1 (not shown in FIG. 10, but shown in FIGS. 1A, 3A, etc.). During operation, the lightguide 1 is deformed (bent, as described for the inventive embodiments discussed hereinabove). This bending deformation causes variations of the output light signal 6 that is detected by the light signal receiver 3 and converted therein into an electric signal 10-7, further sent to the CPU 10-1.

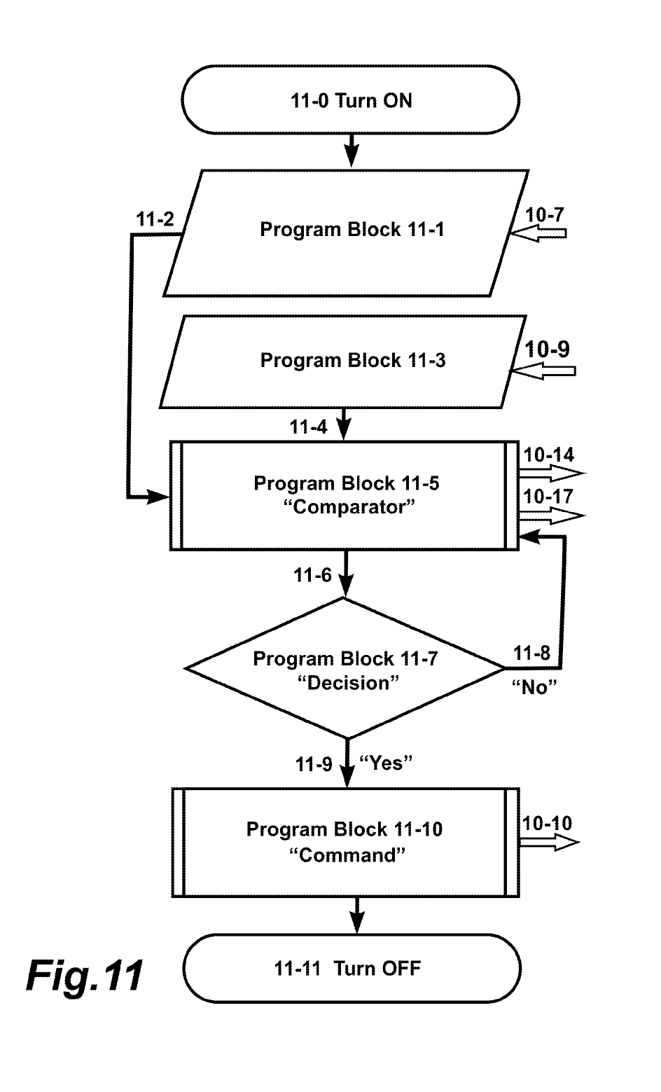

According to a program (for example, based on an algorithm shown in FIG. 11), the CPU 10-1 processes the signal 10-7, input data 10-9 received from the data entry unit 10-8 (e.g. the operator's or external computer's commands, etc.), and input data 10-16 received from the network 10-15 (e.g. results of processing of collected data arrays, etc.). The results of processing are transmitted to: the feedback unit 10-5 as an output signal 10-10 (the feedback unit 10-5 can provide for a light or sound alarm signal, or activate an actuator, such as a vibrator, motor, electrodes for changes or termination of a treatment procedure of the patient); the network 10-15 as an output signal 10-14; the database 10-18; the light signal source 2 as an output signal 10-2.

The aforementioned signals 10-7, input data 10-9, 10-16, output signals 10-10, 10-14, and 10-2 (e.g. results of previous measurements, calculations, characteristics of external objects being monitored, etc.) are transmitted as output signals 10-17, stored in the external database 10-18, and then can be used by the CPU 10-1 in the form of input data 10-19 from the database 10-18.

An example of a table structure being part of the database 10-18 (e.g. for the embodiment depicted in FIG. 9B) is shown below:

TABLE 1
Use of Optical Sensor for Monitoring/Training of Spine

| Database Fields (Example for Spine Correction & | Record Numbers: | | | |
|---|---|---|---|---|
| Training Purposes) | 1 | 2 | . . . | X |

| | |
|---|---|
| 1. | Patient Identification (ID; Last Name, First |
| | Name; Date of Birth; Data & Characteristics: |
| | height, weight, objective & subjective health |
| | conditions, doctor's information, etc.). |
| 2. | Date, session start time (observation, studying, |
| | monitoring), session end time, last session date. |
| 3. | Selection of training intensity mode, selection of |
| | monitoring type (if such options available). |
| 4. | Threshold boundary value (expressed in absolute, |
| | and/or relative, and/or frequency amount). |
| 5. | Dynamics of the threshold boundary value during |
| | the current training session (absolute, and/or |
| | relative amount of inclination angles of the |
| | thoracic section of spine). |
| 6. | Number of work mode events during the session |
| | (or frequency of work mode events per time unit, |
| | e.g. triggering the feedback unit as a result of |
| | patient's spine deformation exceeding a preset |
| | angular limit). |
| 7. | Number of training sessions for the last day |
| | (week, decade, month). |
| 8. | Other data and sections . . . |

FIG. 11 shows a flowchart depicting an algorithm for signal processing in the control system, depicted in FIG. 10, e.g. for the inventive embodiments illustrated in FIGS. 9A, 9B, 9C and 9D. A similar algorithm for signal processing in the control system can be used for the other inventive embodiments described hereinabove. The electric signals 10-7 are received in a program block 11-1 processing the electrical signals, obtaining therefrom at least one predetermined parameter regarding the variations of the output light signal, and encoding it as data 11-2, which are then sent to a program comparator block 11-5. The algorithm begins with a block 11-0 “Turn ON”. A program block 11-3 receives data 10-9 from the data entry unit 10-8 (shown in FIG. 10), saves the data, and encodes the data, for example, into threshold values 11-4 (an example of the threshold values is a preset limit for the patient's spine deformation, such as a declination angle of the patient's spine—see FIGS. 9A, 9B, 9C and 9D), which are then sent to the comparator block 11-5. The comparator block 11-5 also receives the input data 10-19 from the database 10-18. Results 11-6 of processing of the data 11-2, 11-4 and 10-19 in the comparator block 11-5 are sent to a program block 11-7 for making a decision if the threshold values were exceeded or not. If the decision result 11-8 is “No”, then the control returns to the comparator block 11-5 for a next cycle. If the decision result 11-9 is “Yes”, then it's sent to a program command block 11-10, which sends a command 10-10 to the feedback unit 10-5. A program block 11-11 “Turn OFF” finishes the algorithm.

An example of a training/monitoring of a patient's spine, according to the inventive embodiment shown in FIG. 9A and outlined in Table 1 follows: the optical sensor 7 is installed on the patient's body. An operator (the patient, or a medical doctor, or physical therapist, etc.) enters the data 10-9 (e.g. Patient ID, Date, Time, Training Mode, Threshold Values) via the data entry unit 10-8. The data 10-9 can optionally be entered automatically (e.g. from an external computer's program, etc.). The program block 11-3 sends the data 11-4 to the comparator block 11-5, which periodically compares the optical sensor's signals (e.g. proportional to the actual spine positions of the patient) with the entered data (preset threshold values or preset frequency values), records the results into the database, and sends the results to the program block 11-7 for decision making. The block 11-7 either instructs to continue the comparison cycles, or to send a command to the feedback unit 10-5 (e.g. to provide a light or sound alarm signal). The cycles are repeated until the end of training session, or upon reaching a preset limit number of work mode events (e.g. of alarm signals).

We claim:

1. A device for detecting body deformations of a solid body; said device comprising:
a light signal source;
a light signal receiver;
an elongated lightguide capable of elastic deformation, attached to the solid body, said lightguide has a first guide end and a second guide end;
wherein:
the light signal source is optically connected to the first guide end, and the light signal source emits a light signal;
the light signal receiver is optically connected to the second guide end, and the light signal receiver receives the light signal and detects variations of the light signal;
the lightguide provides for a transmission of the light signal therethrough; the lightguide includes predetermined optical inhomogeneities and/or imperfections imparted thereinto; and
wherein said body deformations effect lightguide deformations of said lightguide, thereby producing said variations of the light signal.

2. The device according to claim 1, wherein said lightguide has a longitudinal length, and said lightguide is attached to said solid body entirely or partially along the longitudinal length.

3. The device according to claim 2, wherein said solid body is a portion of a human body.

4. The device according to claim 3, wherein said portion of a human body is a spine.

5. The device according to claim 1, wherein the light signal receiver further converts said light signal into an electrical signal; said light signal receiver is connected to a control system including: a unit for receiving said electrical signal from the light signal receiver, processing said electrical signal and obtaining at least one predetermined parameter thereof; a unit for setting a limit for said at least one predetermined parameter; a comparator unit for comparing said at least one predetermined parameter and the limit; and a feedback unit, producing a feedback command when said at least one predetermined parameter exceeds the limit.

6. A device for detecting mechanical movements of a solid body in relation to an elongated lightguide; said device comprising:
a light signal source;
a light signal receiver; and
the lightguide capable of elastic deformation, including a free lightguide zone detached from the solid body and an attachment lightguide zone attached to the solid body in at least one body zone of the solid body; said lightguide has a first guide end and a second guide end;
wherein:
the light signal source is optically connected to the first guide end, and the light signal source emits a light signal;
the light signal receiver is optically connected to the second guide end, and the light signal receiver receives the light signal and detects variations of the light signal;
the lightguide provides for a transmission of the light signal therethrough; the lightguide includes predetermined optical inhomogeneities and/or imperfections imparted thereinto; and
wherein said mechanical movements effect deformations of said lightguide, thereby producing said variations of the light signal.

7. The device according to claim 6, wherein said solid body is a portion of a human body.

8. The device according to claim 7, wherein said portion of a human body is a spine.

9. The device according to claim 6, wherein, during the mechanical movements, said free zone is moved relative to the solid body by inertial forces, thereby producing said variations reflecting an acceleration or deceleration of the mechanical movements.

10. The device according to claim 6, wherein, during the mechanical movements, said free zone is engaged in oscillations relative to the solid body, thereby producing said variations reflecting the oscillations.

11. The device according to claim 6, wherein the mechanical movements are caused by a movement of a fluid flow affecting said free zone, thereby producing said variations reflecting the movement of the fluid flow.

12. The device according to claim 6, wherein said predetermined optical inhomogeneities and/or imperfections are made in the form of: fluid or vacuum inclusions; or solid particles, imparted into the lightguide during manufacturing thereof by utilizing: fermentation, or casting, or 3-D printing, or treatment by a laser beam.

13. The device according to claim 6, wherein the light signal receiver further converts said light signal into an electrical signal; said light signal receiver is connected to a control system including: a unit for receiving said electrical signal from the light signal receiver, processing said electrical signal and obtaining at least one predetermined parameter thereof; a unit for setting a limit for said at least one predetermined parameter; a comparator unit for comparing said at least one predetermined parameter and the limit; and a feedback unit, producing a feedback command when said at least one predetermined parameter exceeds the limit.

14. A device for detecting body deformations of a solid body; said device comprising:
a light signal source;
a light signal receiver;
a lightguide capable of elastic deformation, attached to the solid body, said lightguide has a first guide end and a second guide end;
wherein:
the light signal source is optically connected to the first guide end, and the light signal source emits a light signal; the light signal receiver is optically connected to the second guide end, and the light signal receiver receives the light signal and detects variations of the light signal;
wherein:
the lightguide is made in the form of a plurality of pieces separated from each other by gaps;
said plurality of pieces are capable of moving in relation to each other;
said plurality of pieces and said gaps are capable of transmitting light signals; and
said body deformations effect lightguide deformations of said lightguide, thereby producing said variations of the light signal.

15. The device according to claim 14, wherein said solid body is a portion of a human body.

16. The device according to claim 15, wherein said portion of a human body is a spine.

17. The device according to claim 14, wherein the light signal receiver further converts said light signal into an electrical signal; said light signal receiver is connected to a control system including: a unit for receiving said electrical signal from the light signal receiver, processing said electrical signal and obtaining at least one predetermined parameter thereof; a unit for setting a limit for said at least one predetermined parameter; a comparator unit for comparing said at least one predetermined parameter and the limit; and a feedback unit, producing a feedback command when said at least one predetermined parameter exceeds the limit.

18. A method of use of the device according to claim 1; said method comprising the steps of:
providing said device;
emitting the light signal by the light signal source;
transmitting the light signal through said lightguide;
providing the body deformations, thereby effecting lightguide deformations; and
producing said variations of the light signal detected by the light signal receiver.

19. A method of use of the device according to claim 6; said method comprising the steps of:
providing said device;
emitting the light signal by the light signal source;
transmitting the light signal through said lightguide;
providing the mechanical movements, thereby effecting the lightguide deformations; and
producing said variations of the light signal detected by the light signal receiver.

20. A method of use of the device according to claim 14; said method comprising the steps of:
providing said device;
emitting the light signal by the light signal source;
transmitting the light signal through said lightguide;
providing the body deformations, thereby effecting lightguide deformations; and
producing said variations of the light signal detected by the light signal receiver.

21. A device for detecting mechanical movements of parts of a solid body; said device comprising:
a light signal source;
a light signal receiver; and
a lightguide;
wherein:
the lightguide is at least partially attached to the solid body, said lightguide has a first guide end and a second guide end; the light signal source is optically connected to the first guide end, and the light signal source emits a light signal; the light signal receiver is optically connected to the second guide end, and the light signal receiver receives the light signal and detects variations of the light signal;
the lightguide is made in the form of a plurality of pieces separated from each other by gaps;
said plurality of pieces are capable of moving in relation to each other;
said plurality of pieces and said gaps are capable of transmitting light signals; and
said mechanical movements of parts of the solid body effect said moving of the plurality of pieces of the lightguide in relation to each other, thereby producing said variations of the light signal.

22. The device according to claim 21, wherein said solid body is a portion of a human body.

23. The device according to claim 21, wherein said portion of a human body is a spine.

24. The device according to claim 24, wherein the light signal receiver further converts said light signal into an electrical signal; said light signal receiver is connected to a control system including: a unit for receiving said electrical signal from the light signal receiver, processing said electrical signal and obtaining at least one predetermined parameter thereof; a unit for setting a limit for said at least one predetermined parameter; a comparator unit for comparing said at least one predetermined parameter and the limit; and a feedback unit, producing a feedback command when said at least one predetermined parameter exceeds the limit.

25. A method of use of the device according to claim 21; said method comprising the steps of:
providing said device;
emitting the light signal by the light signal source;
transmitting the light signal through said lightguide;
providing the mechanical movements of parts of the solid body, thereby effecting said moving of the plurality of pieces of the lightguide in relation to each other; and
producing said variations of the light signal detected by the light signal receiver.
